(19) United States
(12) Patent Application Publication
(10) Pub. No.: US 2023/0097075 A1
(43) Pub. Date: Mar. 30, 2023

(54) MEASURING APPARATUS, MEASURING METHOD, AND ION-SENSITIVE SEMICONDUCTOR DEVICE

(71) Applicant: LAPIS Semiconductor Co., Ltd., Yokohama-shi (JP)

(72) Inventor: Masao OKIHARA, Yokohama-shi (JP)

(73) Assignee: LAPIS Semiconductor Co., Ltd., Yokohama-shi (JP)

(21) Appl. No.: 17/954,125

(22) Filed: Sep. 27, 2022

(30) Foreign Application Priority Data
Sep. 29, 2021 (JP) 2021-160096

(51) Int. Cl. G01N 27/414; G01N 27/416

(52) U.S. Cl. CPC G01N 27/4148; G01N 27/4165

(57) ABSTRACT

A measuring apparatus, includes: a first and a second ion-sensitive semiconductor elements and a reference electrode disposed so as to contact a medium of which a characteristic value is to be measured; a signal input unit receiving a first and a second signals from the first and the second ion-sensitive semiconductor elements, and generating a sensor signal; a processor processing the sensor signal; and a memory storing first data relating to fluctuations over time of the first and the second ion-sensitive semiconductor elements, and connected to the processor, wherein: the processor processes the sensor signal by using the first data and a cumulative energization time of the first and the second ion-sensitive semiconductor elements, and generate an output signal for the characteristic value, the first ion-sensitive semiconductor element includes a first sensitive film, the second ion-sensitive semiconductor element includes a second sensitive film different from the first material.

### CROSS-REFERENCE TO RELATED APPLICATION

This application is based on and claims priority under 35 USC 119 from Japanese Patent Application No. 2021-160096 filed on Sep. 29, 2021, the disclosure of which is incorporated by reference herein.

### BACKGROUND

### Technical Field

The present disclosure relates to a measuring apparatus, a measuring method, and an ion-sensitive semiconductor device.

### Related Art

Japanese Patent Application Laid-Open (JP-A) No. 2016-180711 discloses an electrochemical sensor. The electrochemical sensor includes a sensor portion having a field effect transistor. The electrochemical sensor has a comparator circuit that compares a characteristic value measured at the sensor portion and a target value of the characteristic value of the sensor portion, a circuit that, from the results of comparison, computes a voltage condition for injecting charges into a charge accumulating film, and a control circuit that carries out control so as to apply voltage of the condition computed at that circuit to the sensor portion.

In an ion-sensitive semiconductor element, e.g., the ion-sensitive field effect transistor of JP-A No. 2016-180711, when the sensitive film thereof is immersed in an aqueous solution for pH measurement, the output voltage of the ion-sensitive semiconductor element fluctuates.

Specifically, there are cases in which an ion-sensitive semiconductor element is used continuously over a long period of time for continuous monitoring of a medium such as, for example, soil or an aqueous solution. In this case, drift occurs in the output of the ion-sensitive semiconductor element, and specifically, the pH sensor. The accuracy of measurement of the pH sensor deteriorates due to this drift.

The output drift of the pH sensor can be eliminated or reduced by carrying out an additional measurement for calibration each time the characteristic value of the medium is measured. However, in addition to the time required for measuring the characteristic value, this additional measurement requires additional time for measurement, and further, this additional time accumulates in accordance with the number of times that measurement of the characteristic value is carried out.

### SUMMARY

The present disclosure provides a measuring apparatus, a measuring method and an ion-sensitive semiconductor device that can avoid additional measurement each time a characteristic value is measured.

A measuring apparatus relating to a first aspect of the present disclosure includes: a first ion-sensitive semiconductor element disposed so as to be able to contact a medium of which a characteristic value is to be measured; a second ion-sensitive semiconductor element disposed so as to be able to contact the medium; a reference electrode, the medium being positioned between the reference electrode and the first and the second ion-sensitive semiconductor elements, and the reference electrode being disposed so as to be able to contact the medium; a signal input unit configured to receive a first signal from the first ion-sensitive semiconductor element and a second signal from the second ion-sensitive semiconductor element, and generate a sensor signal; a processor connected to the signal input unit and configured to process the sensor signal; and a memory configured to store first data relating to fluctuations over time of the first ion-sensitive semiconductor element and the second ion-sensitive semiconductor element, and connected to the processor such that communication between the processor and the memory is possible, wherein: the processor is configured so as to process the sensor signal by using the first data and a cumulative energization time of the first ion-sensitive semiconductor element and the second ion-sensitive semiconductor element, and generate an output signal for the characteristic value of the medium, a first sensitive film of the first ion-sensitive semiconductor element includes a first material, a second sensitive film of the second ion-sensitive semiconductor element includes a second material, and the first material is different from the second material.

In accordance with this measuring apparatus, the first ion-sensitive semiconductor element that has the first sensitive film and the second ion-sensitive semiconductor element that has the second sensitive film exhibit different fluctuations over time. On the basis of first data that expresses this difference in the fluctuations over time, the processor processes the sensor signal from the first ion-sensitive semiconductor element and the second ion-sensitive semiconductor element. Due to this processing, the processor can generate an output signal for a characteristic value (e.g., the pH) relating to ions of the medium. When the first data, the first ion-sensitive semiconductor element and the second ion-sensitive semiconductor element are used, the effects of fluctuations over time of the first ion-sensitive semiconductor element and the second ion-sensitive semiconductor element are reduced in the output signal. Further, the measuring apparatus can avoid measurement that is carried out each time the characteristic value of the medium is measured, in order to compensate for fluctuations over time.

The measuring apparatus relating to the first aspect of the present disclosure further includes a timer that measures an energization time over which the first ion-sensitive semiconductor element and the second ion-sensitive semiconductor element are energized, wherein the processor updates the cumulative energization time based on the energization time, and the memory stores the updated cumulative energization time received from the processor.

In accordance with this measuring apparatus, the energization time of the timer within the measuring apparatus is updated, for example, each time energization of the first ion-sensitive semiconductor element and the second ion-sensitive semiconductor element ends. The memory stores the updated cumulative energization time.

The measuring apparatus relating to the first aspect of the present disclosure further includes a temperature sensor for monitoring a temperature of the first ion-sensitive semiconductor element and the second ion-sensitive semiconductor element, wherein the temperature sensor generates a temperature signal expressing the temperature, the memory stores second data that relates to changes, with respect to temperature, in the fluctuations over time of the first ion-sensitive semiconductor element and the second ion-sensitive semiconductor element, and the processor processes the sensor signal by using the second data and the temperature signal, and generates the output signal.

In accordance with this measuring apparatus, fluctuations over time of the first ion-sensitive semiconductor element that has the first sensitive film and the second ion-sensitive semiconductor element that has the second sensitive film exhibit temperature dependency. The processor processes the sensor signal on the basis of the second data that expresses this temperature dependency. Due to this processing, the processor can generate an output signal for the characteristic value of the medium, and effects of the fluctuations over time, with respect to temperature, are reduced in this output signal.

In the measuring apparatus relating to the first aspect of the present disclosure, the characteristic value includes a hydrogen ion concentration (pH) of the medium, the first sensitive film of the first ion-sensitive semiconductor element includes at least one of silicon oxide, silicon nitride, aluminum oxide, or tantalum oxide, and the second sensitive film of the second ion-sensitive semiconductor element includes at least one of silicon oxide, silicon nitride, aluminum oxide or tantalum oxide, so as to differ from the first sensitive film.

In accordance with this measuring apparatus, the first ion-sensitive semiconductor element has the first sensitive film that includes at least one of silicon oxide, silicon nitride, aluminum oxide, or tantalum oxide. The second ion-sensitive semiconductor element has the second sensitive film that includes at least one of silicon oxide, silicon nitride, aluminum oxide, or tantalum oxide, so as to differ from the first sensitive film. By combining these materials, a clear difference in fluctuations over time can be brought about in the first ion-sensitive semiconductor element and the second ion-sensitive semiconductor element.

A measuring method that measures a characteristic of a medium and relates to a second aspect of the present disclosure includes: causing an ion-sensitive semiconductor device, which includes a first ion-sensitive semiconductor element having a first sensitive film of a first material and a second ion-sensitive semiconductor element having a second sensitive film of a second material that is different from the first material, to contact a medium of which a characteristic value is to be measured; energizing a reference electrode that is made to contact the medium such that the medium is positioned between the reference electrode and the ion-sensitive semiconductor device; after energizing the reference electrode and causing the ion-sensitive semiconductor device to contact the medium, obtaining a sensor signal relating to the medium from the first ion-sensitive semiconductor element and the second ion-sensitive semiconductor element; and processing, by a processor, the sensor signal on the basis of first data relating to fluctuations over time of the first ion-sensitive semiconductor element and the second ion-sensitive semiconductor element, and a cumulative energization time of the ion-sensitive semiconductor device, so as to generate an output signal for the characteristic value.

In accordance with this measuring method, the first ion-sensitive semiconductor element that has the first sensitive film and the second ion-sensitive semiconductor element that has the second sensitive film exhibit different fluctuations over time. On the basis of the first data that expresses this difference in the fluctuations over time, the sensor signal from the first ion-sensitive semiconductor element and the second ion-sensitive semiconductor element is processed so as to generate an output signal relating to a characteristic value (e.g., the pH) of the medium. Due to this processing, a signal for the characteristic value of the medium can be generated, and the effects of fluctuations over time can be reduced in this signal. Further, the measuring method can avoid measurement that is carried out each time the characteristic value of the medium is measured, in order to compensate for fluctuations over time.

The method relating to the second aspect of the present disclosure further includes: measuring, via the processor, an energization time of the first ion-sensitive semiconductor element and the second ion-sensitive semiconductor element, and updating the cumulative energization time using the energization time; and storing, via the processor, the cumulative energization time in a memory.

In accordance with this measuring method, the cumulative value of the measured energization time of the ion-sensitive semiconductor device is updated, for example, each time that energization of the first ion-sensitive semiconductor element and the second ion-sensitive semiconductor element ends.

The method relating to the second aspect of the present disclosure further includes sensing, by a temperature sensor, temperature of the ion-sensitive semiconductor device and generating a temperature signal, wherein the obtaining the sensor signal includes the processor processing the sensor signal by further using the temperature signal and second data relating to temperature changes in the fluctuations over time, and generating the output signal.

In accordance with this measuring method, fluctuations over time of the first ion-sensitive semiconductor element that has the first sensitive film and the second ion-sensitive semiconductor element that has the second sensitive film exhibit temperature dependency. The sensor signal is processed by additionally using the second data that expresses this temperature dependency, so as to generate an output signal for the characteristic value of the medium. Due to this processing, a signal for a characteristic value (e.g., the pH) of the medium can be generated, and effects of temperature dependency in the fluctuations over time can be reduced in this signal.

An ion-sensitive semiconductor device relating to a third aspect of the present disclosure includes: a substrate having a semiconductor region of a first conductive type; an insulating film having a first sensor window and a second sensor window, and provided on the substrate; a first sensitive film provided between a first portion of the semiconductor region and the first sensor window, and including a first material; a first source region of a second conductive type that is different from the first conductive type, the first source region being provided at the semiconductor region; a first drain region of the second conductive type, the first drain region being provided at the semiconductor region; a second sensitive film provided between a second portion of the semiconductor region and the second sensor window, and including a second material; a second source region of the second conductive type, the second source region being provided at the semiconductor region; and a second drain region of the second conductive type, the second drain region being provided at the semiconductor region, wherein: the first sensor window reaches the first sensitive film, the second sensor window reaches the second sensitive film, the first portion of the semiconductor region is between the first source region and the first drain region, the second portion of the semiconductor region is between the second source region and the second drain region, and the first material of the first sensitive film is different from the second material of the second sensitive film.

In accordance with this ion-sensitive semiconductor device, at least two field effect ion-sensitive semiconductor elements are provided on a same substrate. These ion-sensitive semiconductor elements differ from one another with respect to the point of the materials of the sensitive films thereof, and have other characteristics that are basically alike one another. In accordance therewith, differences in fluctuations over time that arise due to the differences in the sensitive films can be made to be conspicuous.

In accordance with the present disclosure, there can be provided a measuring apparatus, a measuring method and an ion-sensitive semiconductor device that can avoid additional measurement each time a characteristic value is measured.

### BRIEF DESCRIPTION OF THE DRAWINGS

Exemplary embodiments of the present disclosure will be described in detail based on the following figures, wherein:

FIG. 1 is a drawing schematically illustrating a measuring apparatus relating to a present embodiment;

FIG. 2 is a drawing schematically illustrating an ion-sensitive semiconductor device relating to the present embodiment;

FIG. 3 is a drawing schematically illustrating the cross-section taken along line III-III of FIG. 2;

FIG. 4 is a drawing illustrating exemplary steps of a measuring method relating to the present embodiment;

FIG. 5 is a graph illustrating fluctuations over time of ion-sensitive semiconductor elements;

FIG. 6 is a graph illustrating temperature dependency of the fluctuations over time of the ion-sensitive semiconductor elements;

FIG. 7 is a graph illustrating Arrhenius plots of the temperature characteristics of FIG. 6;

FIG. 8 is a drawing illustrating an example of hardware structures of a processing unit illustrated in FIG. 1; and

FIG. 9 is a drawing schematically illustrating the ion-sensitive semiconductor device relating to an embodiment of the present disclosure.

### DETAILED DESCRIPTION

Embodiments for implementing the present disclosure are described hereinafter with reference to the drawings. Portions that are the same or similar are denoted by the same or similar reference numerals, and redundant description is omitted.

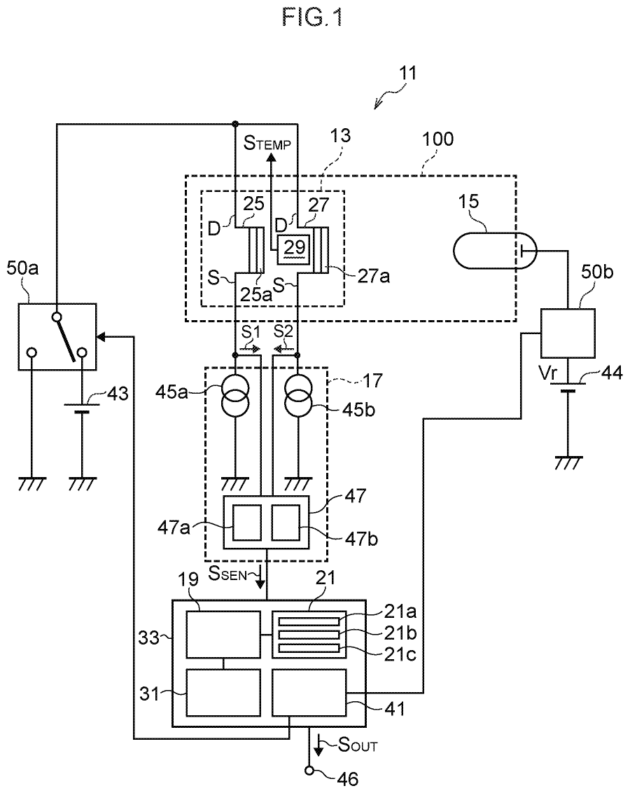

FIG. 1 is a drawing schematically illustrating an example of a measuring apparatus relating to a present embodiment.

A measuring apparatus 11 has an ion-sensitive semiconductor device 13, a reference electrode 15, a signal input unit 17, a signal processing unit 19 and a memory 21.

The ion-sensitive semiconductor device 13 includes a first ion-sensitive semiconductor element 25 and a second ion-sensitive semiconductor element 27. Specifically, each of the first ion-sensitive semiconductor element 25 and the second ion-sensitive semiconductor element 27 has a field effect structure. The ion-sensitive semiconductor device 13, and specifically, the first ion-sensitive semiconductor element 25 and the second ion-sensitive semiconductor element 27, is disposed so as to be able to contact a medium 100 whose characteristic value is to be measured. The characteristic value can be the hydrogen ion concentration (pH) of the medium 100. The first ion-sensitive semiconductor element 25 has a first sensitive film 25a that includes a first material, and the second ion-sensitive semiconductor element 27 has a second sensitive film 27a that includes a second material. The first material is different from the second material.

The reference electrode 15 is provided for the first ion-sensitive semiconductor element 25 and the second ion-sensitive semiconductor element 27. The reference electrode 15 also is disposed so as to be able to contact the medium 100.

The signal input unit 17 receives first signal S1 from the first ion-sensitive semiconductor element 25 and second signal S2 from the second ion-sensitive semiconductor element 27, and generates sensor signal S_{SEN}. The signal processing unit 19 is connected to the signal input unit 17 and processes the sensor signal S_{SEN}. The memory 21 is connected to the signal processing unit 19 such that they can communicate with one another. The memory 21 stores first data 21a that relates to the respective fluctuations over time of the first ion-sensitive semiconductor element 25 and the second ion-sensitive semiconductor element 27.

The signal processing unit 19 processes the sensor signal S_{SEN} by using the first data 21a and a cumulative energization time 21b of the first ion-sensitive semiconductor element 25 and the second ion-sensitive semiconductor element 27, and generates output signal S_{OUT} for the characteristic value of the medium 100 at output 46.

In accordance with the measuring apparatus 11, the first ion-sensitive semiconductor element 25 that has the first sensitive film 25a and the second ion-sensitive semiconductor element 27 that has the second sensitive film 27a exhibit fluctuations over time that are different from one another. On the basis of the first data 21a that expresses the difference in the fluctuations over time, the signal processing unit 19 processes the sensor signal S_{SEN} from the first ion-sensitive semiconductor element 25 and the second ion-sensitive semiconductor element 27. Due to this processing, the signal processing unit 19 can generate the output signal S_{OUT} for a characteristic value (e.g., the pH) relating to ions of the medium 100. When the first data 21a, the first ion-sensitive semiconductor element 25 and the second ion-sensitive semiconductor element 27 are utilized, the effects of the fluctuations over time of the first ion-sensitive semiconductor element 25 and the second ion-sensitive semiconductor element 27 are reduced in the output signal S_{OUT}. Further, the measuring apparatus 11 can avoid calibration measurement that is carried out each time the characteristic value of the medium 100 is measured, in order to compensate for the fluctuations over time. Moreover, the measuring apparatus 11 can acquire a characteristic value of the medium 100 without carrying out calibration over a long period of time.

The signal input unit 17 is connected to respective one terminals S of the first ion-sensitive semiconductor element 25 and the second ion-sensitive semiconductor element 27. Specifically, the signal input unit 17 can include current sources 45a, 45b, and the current sources 45a, 45b are respectively connected between the one terminals S of the first ion-sensitive semiconductor element 25 and the second ion-sensitive semiconductor element 27 and ground wires. The current sources 45a, 45b provide bias current to the ion-sensitive semiconductor elements (25, 27). Further, the signal input unit 17 can include a converting unit 47, and the converting unit 47 processes the first signal S1 and the second signal S2 respectively, and generates the sensor signal S_{SEN}. The converting unit 47 can include one or plural A/D converters. As an example but not a limitation, the converting unit 47 includes A/D converters 47a, 47b. The first signal S1 and the second signal S2 can be processed by the A/D converters 47a, 47b, respectively. In the present embodiment, the signal processing unit 19 and the memory 21 are included in a processing unit 33. The memory 21 has respective areas that store the first data 21a and the value (data) of the cumulative energization time 21b.

The measuring apparatus 11 can further include a timer 31. For example, the timer 31 can measure the energization time over which the first ion-sensitive semiconductor element 25 and the second ion-sensitive semiconductor element 27 are energized. The signal processing unit 19 can update the cumulative energization time 21b on the basis of the energization time, and the memory 21 can store the updated cumulative energization time 21b that is from the signal processing unit 19.

In accordance with this measuring apparatus 11, the energization time that is measured by the timer 31 within the processing unit 33 is updated, for example, each time that energization of the first ion-sensitive semiconductor element 25 and the second ion-sensitive semiconductor element 27 ends. The memory 21 stores the updated cumulative energization time 21b.

Specifically, the measuring apparatus 11 can include a first power source 43 and a second power source 44. The first power source 43 can be connected to respective other terminals D of the first ion-sensitive semiconductor element 25 and the second ion-sensitive semiconductor element 27 via a first switch 50a. In response to a signal from a control unit 41, the first switch 50a can switch the other terminals D of the first ion-sensitive semiconductor element 25 and the second ion-sensitive semiconductor element 27 between the ground wires and the first power source 43. The second power source 44 provides reference voltage Vr, and can be connected to the reference electrode 15 via a second switch 50b. The second switch 50b can have a structure that is similar to that of the first switch 50a.

For example, in response to a signal that controls the opening/closing of the first switch 50a (a signal that the control unit 41 provides to the first switch 50a), the timer 31 can specify the time period from the closing to the opening of the first switch 50a. In the present embodiment, the opening/closing of the second switch 50b is synchronous with the opening/closing of the first switch 50a.

The characteristics of the first ion-sensitive semiconductor element 25 and the second ion-sensitive semiconductor element 27 fluctuate in response to changes in the environmental temperature. In order to compensate for temperature, the measuring apparatus 11 can further include a temperature sensor 29 that is a thermistor, a thermocouple or a PN diode of a semiconductor. The temperature sensor 29 is provided in order to monitor the temperature of the first ion-sensitive semiconductor element 25 and the second ion-sensitive semiconductor element 27. To this end, the temperature sensor 29 can be disposed in a vicinity of the first ion-sensitive semiconductor element 25 and the second ion-sensitive semiconductor element 27. The temperature sensor 29 generates temperature signal S_{TEMP}, which expresses the temperature, on the basis of temperature monitoring of the first ion-sensitive semiconductor element 25 and the second ion-sensitive semiconductor element 27. The temperature signal S_{TEMP} is provided to the processing unit 33.

The memory 21 stores second data 21c. The second data 21c includes values relating to correction (temperature correction) that relates to the fluctuations over time of the first ion-sensitive semiconductor element 25 and the second ion-sensitive semiconductor element 27 varying with respect to temperature.

The signal processing unit 19 processes the sensor signal S_{SEN} by using the second data 21c and the temperature signal S_{TEMP}, and generates the output signal S_{OUT}, which has been temperature-compensated, at the output 46.

In accordance with the measuring apparatus 11, the fluctuations over time of the first ion-sensitive semiconductor element 25 that has the first sensitive film 25a and the second ion-sensitive semiconductor element 27 that has the second sensitive film 27a exhibit temperature dependency. The signal processing unit 19 processes the sensor signal S_{SEN} on the basis of the second data 21c that expresses this temperature dependency. Due to this processing, the signal processing unit 19 can generate the output signal S_{OUT} for the characteristic value of the medium 100, and effects, which are due to the environmental temperature, on the fluctuations over time are reduced in the output signal S_{OUT}.

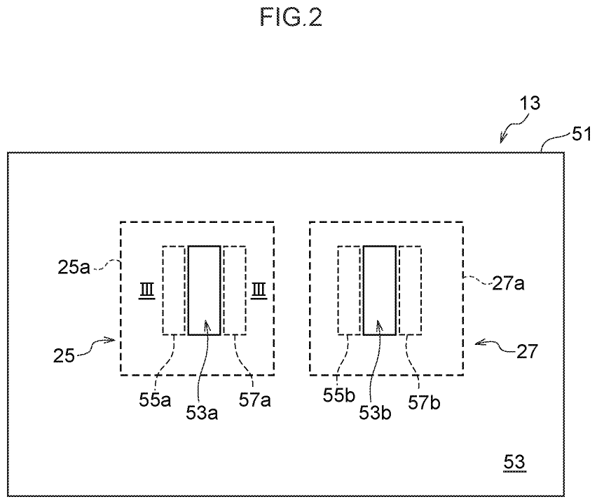

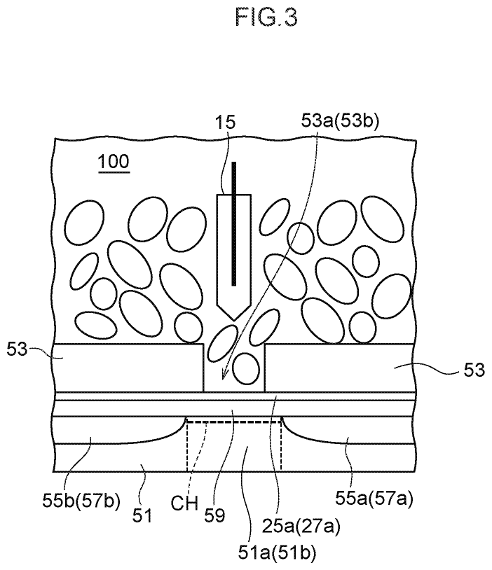

FIG. 2 is a drawing schematically illustrating the ion-sensitive semiconductor device relating to the present embodiment. FIG. 3 is a drawing schematically illustrating the cross-section taken along line III-III of FIG. 2.

Referring to FIG. 2, the ion-sensitive semiconductor device 13 is provided in the form of a semiconductor chip, and this semiconductor chip includes the first ion-sensitive semiconductor element 25 and the second ion-sensitive semiconductor element 27. As an example but not a limitation, the temperature sensor 29, e.g., a resistor, can be integrated together with the first ion-sensitive semiconductor element 25 and the second ion-sensitive semiconductor element 27. As an example but not a limitation, the first ion-sensitive semiconductor element 25 and the second ion-sensitive semiconductor element 27 can be arrayed in parallel in the same direction at the ion-sensitive semiconductor device 13.

The first material of the first sensitive film 25a of the first ion-sensitive semiconductor element 25 can include at least one of silicon oxide (e.g., SiO₂), silicon nitride (e.g., Si₃N₄), aluminum oxide (e.g., Al₂O₃), or tantalum oxide (e.g., Ta₂O₅). The second material of the second sensitive film 27a of the second ion-sensitive semiconductor element 27 can include at least one of silicon oxide (e.g., SiO₂), silicon nitride (e.g., Si₃N₄), aluminum oxide (e.g., Al₂O₃), or tantalum oxide (e.g., Ta₂O₅), so as to differ from the first sensitive film 25a. As an example but not a limitation, the first sensitive film 25a can be silicon nitride (e.g., Si₃N₄), and the second sensitive film 27a can be tantalum oxide (e.g., Ta₂O₅).

In accordance with this measuring apparatus 11, a clear difference in the fluctuations over time manifests at the first ion-sensitive semiconductor element 25 and the second ion-sensitive semiconductor element 27 in accordance with the combination of these materials.

The semiconductor device structure for the first ion-sensitive semiconductor element 25 and the second ion-sensitive semiconductor element 27 illustrated in FIG. 2 is illustrated with reference to FIG. 3. Because the first ion-sensitive semiconductor element 25 and the second ion-sensitive semiconductor element 27 have the same structure, in the following explanation, the first ion-sensitive semiconductor element 25 will be described, and the reference numerals for the second ion-sensitive semiconductor element 27 will be given in parentheses.

The ion-sensitive semiconductor device 13 includes a common substrate 51 for the first ion-sensitive semiconductor element 25 and the second ion-sensitive semiconductor element 27. The substrate 51 has a semiconductor region of a first conductive type (e.g., p-type), and can be a p-type silicon substrate for example. The substrate 51 includes a first portion 51a for channel CH of the first ion-sensitive semiconductor element 25 (a second portion 51b for channel CH of the second ion-sensitive semiconductor element 27). The ion-sensitive semiconductor device 13 further includes an insulating film 53, the first sensitive film 25a (second sensitive film 27a), a first source region 55a (second source region 57a), and a first drain region 55b (second drain region 57b). The first source region 55a (second source region 57a) is indicated by “S” in FIG. 1, and the first drain region 55b (second drain region 57b) is indicated by “D” in FIG. 1.

The insulating film 53 covers the substrate 51, and has a first sensor window 53a for the first ion-sensitive semiconductor element 25 (second sensor window 53b for the second ion-sensitive semiconductor element 27). The first sensor window 53a (second sensor window 53b) is provided above the first portion 51a (second portion 51b) of the substrate 51. The first sensor window 53a (second sensor window 53b) is provided in the insulating film 53, and reaches the first sensitive film 25a (second sensitive film 27a). The first sensitive film 25a (second sensitive film 27a) is provided between the first portion 51a (second portion 51b) of the semiconductor region of the substrate 51 and the first sensor window 53a (second sensor window 53b). The insulating film 53 includes, for example, silicon oxide or silicon nitride.

The first source region 55a (second source region 57a) includes a second conductive type semiconductor (e.g., an n-type semiconductor) that is provided at the substrate 51, and the first drain region 55b (second drain region 57b) includes a second conductive type semiconductor that is provided at the substrate 51. The first portion 51a (second portion 51b) of the semiconductor region is positioned between the first source region 55a (second source region 57a) and the first drain region 55b (second drain region 57b).

In accordance with the ion-sensitive semiconductor device 13, the at least two field effect type ion-sensitive semiconductor elements 25, 27 are provided on the same substrate 51. On the other hand, these ion-sensitive semiconductor elements 25, 27 that are within the ion-sensitive semiconductor device 13 differ from one another with respect to the point of the materials of the sensitive films (25a, 27a) thereof, and have other characteristics that are basically alike one another. In accordance therewith, the difference in the fluctuations over time that arises due to the difference in the sensitive films (25a, 27a) can be made to be conspicuous.

As an example but not a limitation, the first sensor window 53a and the second sensor window 53b exist in the same direction within the insulating film 53 that is on the substrate 51.

The first sensor window 53a and the second sensor window 53b each include a through-hole that passes through the insulating film 53, and are used in order to control the channels CH at the first portion 51a of the semiconductor region of the substrate 51. Specifically, the medium 100 illustrated in FIG. 1 enters into this through-hole and contacts the first sensitive film 25a (second sensitive film 27a).

The channel CH is formed directly beneath the first sensor window 53a (second sensor window 53b) in accordance with the potential of the reference electrode 15 and the electrical characteristics of the medium 100. The channel CH that is directly beneath the first sensor window 53a (the second sensor window 53b) can contact both the first source region 55a (second source region 57a) and the first drain region 55b (second drain region 57b).

As an example but not a limitation, the first sensor window 53a (second sensor window 53b) is separated from the semiconductor region of the substrate 51 by a gate insulating film. In the present embodiment, in order to obtain a good channel CH, the gate insulating film of the first ion-sensitive semiconductor element 25 (27) includes the first sensitive film 25a (27a) and a silicon oxide film 59 (e.g., a thermal oxidation film), and this silicon oxide film 59 forms the interface with the semiconductor region of the substrate 51.

The ion-sensitive semiconductor device 13 can be fabricated as follows for example. A p-type silicon wafer is prepared. Element-separating silicon oxide regions for separating the plural ion-sensitive semiconductor elements are formed on the p-type silicon wafer. The element-separating silicon oxide regions prescribe the respective element areas of the ion-sensitive semiconductor elements (25, 27). Gate oxide films are formed at the element areas of the p-type silicon wafer by thermal oxidation. At one element area, the first sensitive film (e.g., a silicon nitride film) is formed on the gate oxide film by using deposition, photolithography and etching. At another element area, the second sensitive film (e.g., a tantalum oxide film) is formed on the gate oxide film by using deposition, photolithography and etching. After these are formed, dopants for the n-type source regions and the n-type drain regions are introduced into both element areas by photolithography and ion injection. After this introduction, an insulating film is deposited on the entire surface of the silicon wafer. Sensor windows are formed in the insulating film by using photolithography and etching. After the sensor windows are formed, metallization for electrode formation is carried out.

As an example but not a limitation, the first ion-sensitive semiconductor element 25 and the second ion-sensitive semiconductor element 27 can be provided on different semiconductor substrates.

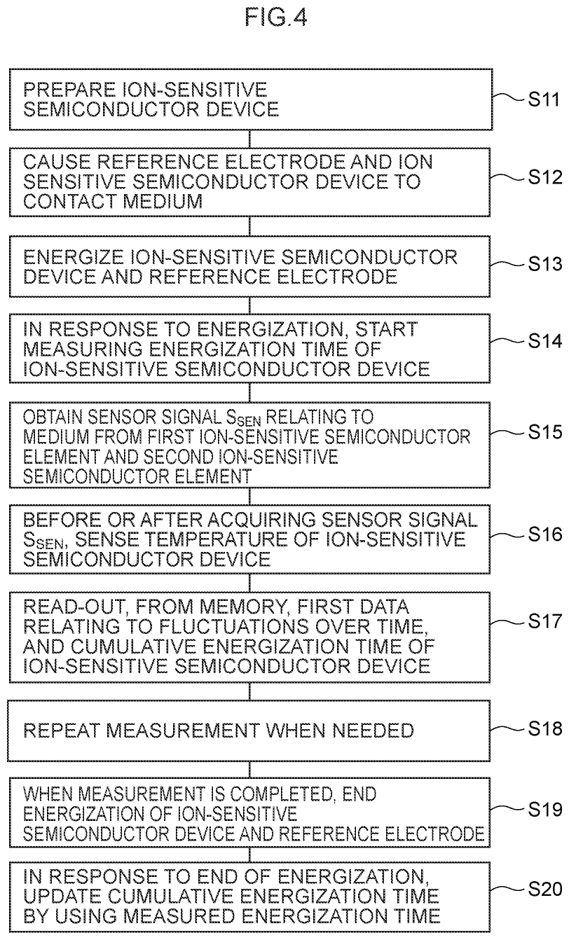

FIG. 4 is a drawing illustrating exemplary steps of a measuring method relating to the present embodiment. A method of measuring a characteristic of the medium 100 is described as an example of the measuring method. In the following description, the reference numerals that are used in FIG. 1 through FIG. 3 are used when possible in order to facilitate understanding.

In step S11, the first ion-sensitive semiconductor element 25 that has the first sensitive film 25a and the second ion-sensitive semiconductor element 27 that has the second sensitive film 27a are prepared. This preparing of the ion-sensitive semiconductor elements 25, 27 includes fabrication of the first ion-sensitive semiconductor element 25 and the second ion-sensitive semiconductor element 27, or acquisition of the first ion-sensitive semiconductor element 25 and the second ion-sensitive semiconductor element 27 by a method other than fabrication. As an example but not a limitation, the first ion-sensitive semiconductor element 25 and the second ion-sensitive semiconductor element 27 are provided within the ion-sensitive semiconductor device 13.

In step S12, the reference electrode 15, and the first ion-sensitive semiconductor element 25 and the second ion-sensitive semiconductor element 27, are made to contact the medium 100 whose characteristic is to be measured. For example, in a state in which the first ion-sensitive semiconductor element 25 and the second ion-sensitive semiconductor element 27 are disposed within a container and so as to be apart from the reference electrode 15, the medium 100, e.g., a liquid, is placed in the container. Or, in a state in which the first ion-sensitive semiconductor element 25 and the second ion-sensitive semiconductor element 27 are disposed within a container and so as to be apart from the reference electrode 15, the medium 100, e.g., soil, is placed in the container.

In step S13, the ion-sensitive semiconductor device 13 and the reference electrode 15 are energized. For example, at the measuring apparatus 11 illustrated in FIG. 1, the switch 50a and the switch 50b are made conductive.

In step S14, in response to the energization, measuring of the energization time of the first ion-sensitive semiconductor element 25 and the second ion-sensitive semiconductor element 27 is started. For example, the timer 31 of the measuring apparatus 11 can be used in this measurement.

In step S15, after contact with the medium 100 and the above-described energization, the sensor signal S_{SEN} relating to the medium 100 is obtained from the first ion-sensitive semiconductor element 25 and the second ion-sensitive semiconductor element 27.

Specifically, the channel CH is formed at each of the first ion-sensitive semiconductor element 25 and the second ion-sensitive semiconductor element 27 in accordance with the characteristics of the medium 100. The first ion-sensitive semiconductor element 25 and the second ion-sensitive semiconductor element 27 provide the first signal S1 and the second signal S2 that correspond to the respective, formed channels CH. The first signal S1 and the second signal S2 are generated by circuits that are connected in series to the first ion-sensitive semiconductor element 25 and the second ion-sensitive semiconductor element 27 and the respective current sources 45a, 45b. At the A/D converting unit 47, for example, the first signal S1 and the second signal S2 can be converted serially into digital values by a single A/D converter, or can be converted in parallel into digital values by the A/D converters 47a, 47b. The digital values generated in this way are provided as the sensor signal S_{SEN}.

In step S16, when needed, and before or after acquisition of the sensor signal S_{SEN}, the temperature of the ion-sensitive semiconductor device 13 is sensed, and the temperature signal S_{TEMP} can be generated.

In step S17, the first data 21a that relates to fluctuations over time of the first ion-sensitive semiconductor element 25 and the second ion-sensitive semiconductor element 27, and the cumulative energization time 21b of the ion-sensitive semiconductor device 13, are read-out from the memory 21. On the basis of the read-out first data 21a and cumulative energization time 21b, the sensor signal S_{SEN} is processed, and the output signal S_{OUT} for the characteristic value of the medium 100 is generated.

As described above, the sensed characteristic of the ion-sensitive semiconductor device 13 inevitably varies in accordance with the usage time (i.e., varies over time). The amount of fluctuation over time can be specified by using the first data 21a, from the difference in the first signal S1 and the second signal S2 from the first ion-sensitive semiconductor element 25 and the second ion-sensitive semiconductor element 27.

When needed, at the time of processing the sensor signal S_{SEN}, the second data 21c that relates to temperature changes in the fluctuations over time, and the temperature signal S_{TEMP}, can be used in order to compensate for temperature. The output signal S_{OUT} that has been temperature-compensated may be generated using the second data 21c and the temperature signal S_{TEMP}, in addition to the first data 21a, in processing the sensor signal S_{SEN}.

In accordance with this measuring method, fluctuations over time in the first ion-sensitive semiconductor element 25 and the second ion-sensitive semiconductor element 27 exhibit temperature dependency. On the basis of the second data 21c that expresses this temperature dependency, the sensor signal S_{SEN} is processed so as to provide the output signal S_{OUT}, which has been temperature-compensated, for the characteristic value of the medium 100. Due to this processing, the fluctuations over time of the ion-sensitive semiconductor elements 25, 27, and the temperature dependency of these fluctuations, affecting the measured value of the pH of the medium 100 for example can be reduced.

In step S18, measurement can be repeated when necessary.

In step S19, when measurement is completed, the energizing of the ion-sensitive semiconductor device 13 and the reference electrode 15 is stopped. For example, the switch 50a and the switch 50b in the measuring apparatus 11 illustrated in FIG. 1 are opened.

In step S20, in response to the ending of the energization, the time measured by the timer 31 that started operation in step S14 is read-in. The cumulative energization time 21b is updated by using the measured energization time. This updated cumulative energization time 21b is stored in the memory 21. In accordance with this measuring method, the cumulative value of the measured energization times of the ion-sensitive semiconductor device 13 is updated, for example, each time that energizing of the first ion-sensitive semiconductor element 25 and the second ion-sensitive semiconductor element 27 ends.

Specifically, in accordance with this measuring method, the first ion-sensitive semiconductor element 25 and the second ion-sensitive semiconductor element 27 exhibit different fluctuations over time. On the basis of the first data 21a that expresses this difference in fluctuations over time, the sensor signal S_{SEN} is processed so as to generate the output signal S_{OUT} relating to a characteristic value of the medium 100. Due to this processing, an output signal that expresses a characteristic value (e.g., the pH) can be generated, and the effects of the fluctuations over time can be reduced in this signal. Further, in this measuring method, repetition that is carried out each time the characteristic value of the medium 100 is measured in order to compensate for the fluctuations over time can be avoided. Moreover, a characteristic value of the medium 100 can be obtained without carrying out calibration over a long period of time.

The measuring apparatus 11 can include a calibration measurement mode and a field measurement mode that is different from the calibration measurement mode. The switching between these modes is realized by, for example, the control unit 41 in response to input from the exterior.

The field measurement mode makes measurement of the medium 100 possible at the measuring apparatus 11. The calibration measurement mode makes measurement for the first data 21a and the second data 21c possible at the measuring apparatus 11, and the measuring apparatus 11 can output the signal of the measured value relating to a characteristic value of a standard medium, e.g., the sensor signal S_{SEN}, to the exterior.

Data for the first data 21a and the second data 21c can be prepared from the measured value that is outputted. The first data 21a and the second data 21c that are prepared in this way are stored in the memory 21. In the calibration measurement mode, the measuring apparatus 11 can selectively write a first area (21a) within the memory 21 in order to store the first data 21a. In accordance with this measuring apparatus 11, in a mode other than the calibration measurement mode, the first area (21a) within the memory 21 can be protected from unintentional writing.

In the calibration measurement mode, the measuring apparatus 11 can selectively write a second area (21c) within the memory 21 in order to store the second data 21c. In accordance with this measuring apparatus 11, in a mode other than the calibration measurement mode, the second area (21c) within the memory 21 can be protected from unintentional writing.

In the field measurement mode, the measuring apparatus 11 can write a third area within the memory in order to store the data of the cumulative energization time. In accordance with this measuring apparatus 11, in a mode other than the field measurement mode, the data of the cumulative energization time can be protected.

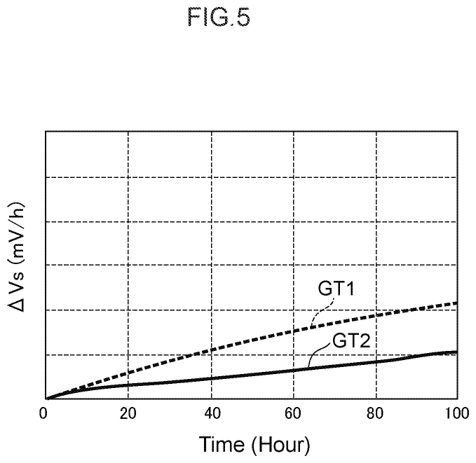

FIG. 5 is a graph illustrating fluctuations over time of the ion-sensitive semiconductor elements. An ion-sensitive semiconductor element having a silicon nitride (Si₃N₄) sensitive film is prepared as the first ion-sensitive semiconductor element 25. Further, an ion-sensitive semiconductor element having a tantalum oxide (Ta₂O₅) sensitive film is prepared as the second ion-sensitive semiconductor element 27.

In FIG. 5, the vertical axis shows the fluctuation rate (the amount of change from the initial value) of the output of the ion-sensitive semiconductor element as a voltage value, and the horizontal axis shows the energization time. In the measurement, the respective ion-sensitive semiconductor elements that have types of sensitive films are immersed in a standard medium (e.g., 40° C., pH 6.86). The drain voltage is, for example, 1.0 to 2.5 volts, and the voltage of the reference electrode is, for example, around 0 to 3 volts.

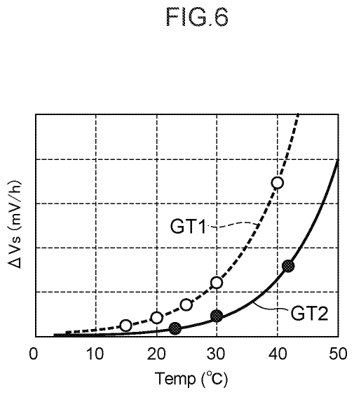

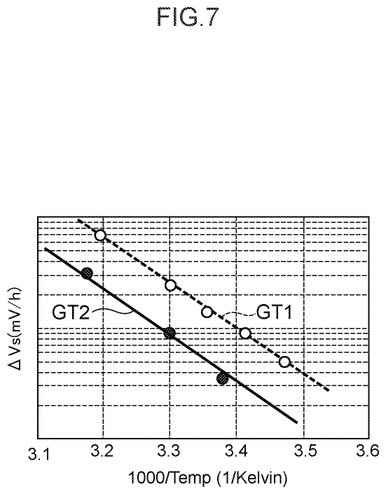

FIG. 6 is a graph illustrating temperature dependency of the rates of fluctuation over time of the output values of the ion-sensitive semiconductor elements. The horizontal axis shows the temperature of a standard medium, and the vertical axis shows the fluctuation rate of the output value of the ion-sensitive semiconductor element. FIG. 7 is a graph illustrating Arrhenius plots of the temperature characteristics of FIG. 6. In FIG. 7, the fluctuation rate is shown on the vertical axis in a logarithmic scale, and the horizontal axis shows the reciprocal of the temperature of the standard medium.

Referring to FIG. 5, two characteristic lines GT1, GT2 are depicted. The characteristic line GT1 illustrates the characteristic of the ion-sensitive semiconductor element that has the silicon nitride sensitive film, and the characteristic line GT2 illustrates the characteristic of the ion-sensitive semiconductor element that has the tantalum oxide sensitive film.

As an example but not a limitation, the characteristics of the ion-sensitive semiconductor elements relating to the embodiment can be approximated as polynomial expressions of time t.

For example, first-degree approximation formulas are as follows.

characteristic 1:Vsa(t)=Vsa0+[pH]×Sa+t×Dsa (1)

characteristic 2:Vsb(t)=Vsb0+[pH]×Sb+t×Dsb (2)

Vsa and Vsb: values obtained by measurement
t: cumulative energization time
[pH]: hydrogen ion concentration
Ss and Sb: coefficients relating to hydrogen ion concentration
Vsa0 and Vsb0: terms (constant terms) that do not depend on time and the hydrogen ion concentration

initial value of characteristic 1:

Vsa(t=0)=Vsa0+[pH]×Sa

initial value of characteristic 2:

Vsb(t=0)=Vsb0+[pH]×Sb

In the graph of FIG. 5, the characteristic lines GT1, GT2 are expressed by coefficients relating to time of the following formulas.

characteristic line 1:ΔVsa(t)=Vsa(t)−Vsa(t=0)=t×Dsa

characteristic line 2:ΔVsb(t)=Vsb(t)−Vsb(t=0)=t×Dsb

Because the [pH] at the time of calibration is known, the coefficients Ss and Sb with respect to the hydrogen ion concentration, the coefficients Dsa and Dsb of the fluctuations over time, and the constant terms Vsa0 and Vsb0 can be specified on the basis of the time dependencies of the measured values Vsa and Vsb. Further, the main portions of the temperature dependencies are the coefficients Dsa and Dsb of the fluctuations over time.

Voltage difference ΔV(t) of the fluctuations over time, i.e., the fluctuation rate with respect to time, is expressed by the difference between the characteristic line GT1 and the characteristic line GT2. Here, ΔVsa(t)>ΔVsb(t) can be assumed without loss of generality.

$$Δ V ( t ) = Δ Vs a ( t ) - Δ Vsb ( t ) = t \times ( Dsa - Dsb )$$

Referring to FIG. 1, at the measuring apparatus 11, the signal input unit 17 receives the signals S1, S2 that can be approximated by formulas (1) and (2) that express the fluctuations over time. Specifically, the measured values S1 and S2 at that time t are expressed as follows.

measured value 1:S1(t)=Vsa0+[pH]×Sa+t×Dsa

measured value 2:S2(t)=Vsb0+[pH]×Sb+t×Dsb

(S1(t)−S2(t))=(Vsa0−Vsb0)+[pH]×(Sa−Sb)+t×(Dsa−Dsb)

The hydrogen ion concentration [pH] is expressed by the following formula.

[pH]=((S1−S2)−(Vsa0−Vsb0)−t×(Dsa−Dsb))/(Sa−Sb) (3)

### Example 1 of First Data 21a

As an example but not a limitation, the memory 21 can store the first data 21a that includes the coefficients (Ss and Sb) for the hydrogen ion concentration, the coefficients (Dsa and Dsb) of the fluctuations over time, and the constant terms (Vsa0 and Vsb0).

By using the first data 21a and the cumulative energization time 21b, the signal processing unit 19 can compute a characteristic value (e.g., the pH) in accordance with approximation formula (3).

### Example 2 of First Data 21a

As an example but not a limitation, the memory 21 can store the first data 21a that includes the coefficient (Ss−Sb) for the hydrogen ion concentration, the coefficient (Dsa−Dsb) of the fluctuations over time, and the constant term (Vsa0−Vsb0).

By using the first data 21a and the cumulative energization time 21b, the signal processing unit 19 can compute a characteristic value (e.g., the pH) in accordance with approximation formula (3).

### Example 3 of First Data 21a

As an example but not a limitation, the memory 21 can store a table that includes plural times (t1, t2, . . . tn) and values (ΔV(t1), ΔV(t2), . . . ΔV(tn)) that are associated with these times, and store the constant term (Vsa0−Vsb0).

The signal processing unit 19 specifies the time that is nearest to the cumulative energization time 21b in the measurement from the times (t1, t2, . . . tn) in the table, and computes a characteristic value (e.g., the pH) in accordance with approximation formula (3) by using the measured values (Vsa and Vsb) at the nearest time and the constant term (Vsa0−Vsb0).

The first data 21a is not limited to the above examples, and can include arbitrary numerical values that express trends exhibited by the characteristic lines GT1 and GT2 (or characteristic 1 and characteristic 2). For example, the first data 21a does not exclude a table of raw measured values that are used in order to specify approximation formulas of characteristic 1 and characteristic 2.

The approximation formula of the characteristic of the ion-sensitive semiconductor element is not limited to a polynomial expression of time, and, for example, can include a transcendental function of time t, or can include both a polynomial expression of time t and a transcendental function of time t.

The second data 21c can include values for the activation energies of characteristic 1 and characteristic 2 that accompany the Arrhenius plots. The signal processing unit 19 processes the sensor signal S_{SEN} by using the second data 21c and the temperature signal S_{TEMP}, and carries out temperature compensation of the sensor signal S_{SEN}.

The second data 21c is not limited to the above-described example, and can include arbitrary numerical values that express trends relating to temperature that are expressed by the characteristic lines GT1 and GT2 (or characteristic 1 and characteristic 2). Moreover, the second data 21c does not exclude a table of the raw measured values of the temperature dependencies expressed by the characteristic lines GT1 and GT2 (or characteristic 1 and characteristic 2).

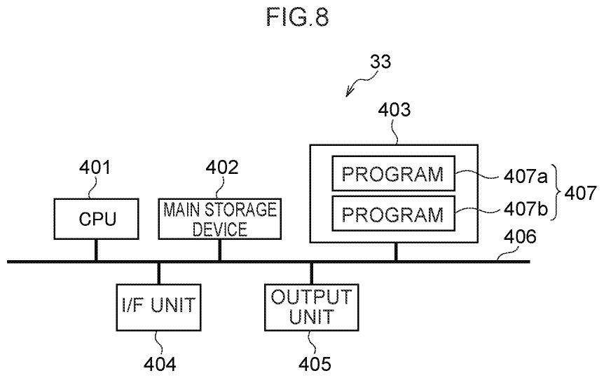

FIG. 8 is a drawing illustrating an example of hardware structures of the processing unit illustrated in FIG. 1. The processing unit 33 is structured by a microcomputer for example, and includes a processor (Central Processing Unit: CPU) 401, a main storage device 402 serving as a temporary storage region, a non-volatile auxiliary storage device 403, an interface unit (I/F unit) 404 that receives signals from the exterior, and an output unit 405 that outputs control signals. The CPU 401, the main storage device 402, the auxiliary storage device 403, the interface unit 404 and the output unit 405 are respectively connected to a bus 406. A measuring program 407 that describes the processes of the measuring processing at the measuring apparatus 11 is stored in the auxiliary storage device 403. For example, due to the CPU 401 executing a first program 407a, the processing unit 33 can provide the calibration measurement mode, and, due to the CPU 401 executing a second program 407b, the processing unit 33 can provide the field measurement mode. Main operations of the processor 401 are as follows.

The processor 401 can be structured so as to control the opening/closing of the switch 50a and the switch 50b for energizing the ion-sensitive semiconductor device 13 and the reference electrode 15.

The processor 401 is structured so as to, in response to control of the energization, start measuring the energization time of the first ion-sensitive semiconductor element 25 and the second ion-sensitive semiconductor element 27 by using the timer 31.

The processor 401 can be structured so as to, after contact of the medium 100 and energization, receive the sensor signal S_{SEN} relating to the medium 100 from the first ion-sensitive semiconductor element 25 and the second ion-sensitive semiconductor element 27.

The processor 401 can be structured so as to receive the temperature signal S_{TEMP} by using the temperature sensor in order to sense the temperature of the ion-sensitive semiconductor device 13, prior to or after or simultaneously with acquiring the sensor signal S_{SEN}.

The processor 401 can be structured so as to read-out, from the memory 21, the first data 21a relating to fluctuations over time of the first ion-sensitive semiconductor element 25 and the second ion-sensitive semiconductor element 27, and the cumulative energization time 21b of the ion-sensitive semiconductor device 13. The processor 401 can be structured so as to process the sensor signal S_{SEN} by using the read-out first data 21a and cumulative energization time 21b, and generate the output signal S_{OUT} for the characteristic value of the medium 100.

The processor 401 can be structured so as to process the sensor signal S_{SEN} by further using the second data 21c relating to temperature changes in the fluctuations over time and the temperature signal S_{TEMP}, and generate the output signal S_{OUT} that has been temperature-compensated.

The processor 401 can be structured so as to repeat measurement (receiving the sensor signal S_{SEN}, and process the sensor signal S_{SEN} and generate the output signal S_{OUT}).

The processor 401 can be structured so as to repeatedly open the switch 50a and the switch 50b in order to stop energization of the ion-sensitive semiconductor device 13 and the reference electrode 15.

The processor 401 can be structured so as to, in response to the end of energization, read the timer 31, and update the cumulative energization time 21b by using the measured energization time. Further, the processor 401 can be structured so as to store the updated cumulative energization time 21b in the memory 21.

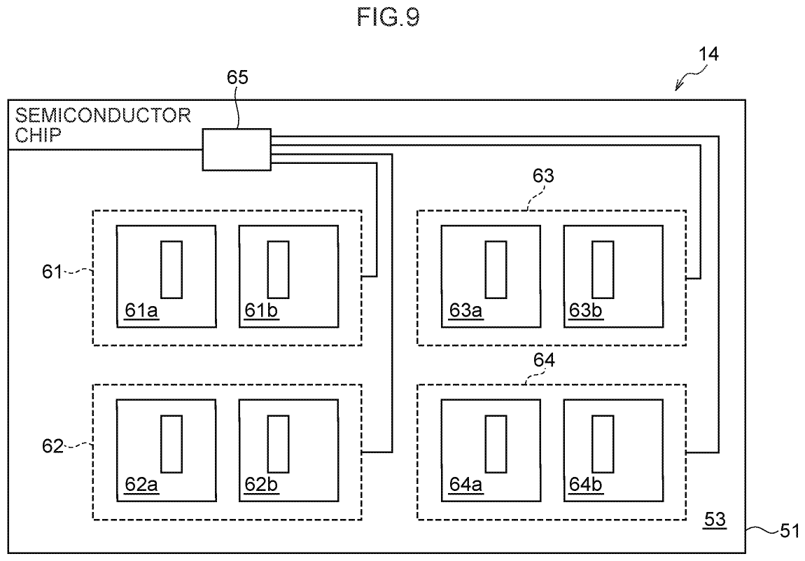

FIG. 9 is a cross-section schematically illustrating an ion-sensitive semiconductor device integrated circuit relating to another embodiment of the present disclosure.

An ion-sensitive semiconductor device integrated circuit 14 can have a plurality of the ion-sensitive semiconductor devices 13. In the present embodiment, the plural ion-sensitive semiconductor devices 13 are referred to as first ion-sensitive semiconductor device 61, second ion-sensitive semiconductor device 62, third ion-sensitive semiconductor device 63, and fourth ion-sensitive semiconductor device 64. The ion-sensitive semiconductor device integrated circuit 14 includes the substrate 51 and the insulating film 53. The first ion-sensitive semiconductor device 61, the second ion-sensitive semiconductor device 62, the third ion-sensitive semiconductor device 63, and the fourth ion-sensitive semiconductor device 64 are integrated on the common substrate 51 that has a semiconductor region of a first conductive type. As illustrated in FIG. 3, the insulating film 53 is provided on the substrate 51.

The first ion-sensitive semiconductor device 61 includes a first ion-sensitive semiconductor element 61a and a second ion-sensitive semiconductor element 61b that are disposed near one another and in parallel. The second ion-sensitive semiconductor device 62 includes a third ion-sensitive semiconductor element 62a and a fourth ion-sensitive semiconductor element 62b that are disposed near one another and in parallel. The third ion-sensitive semiconductor device 63 includes a fifth ion-sensitive semiconductor element 63a and a sixth ion-sensitive semiconductor element 63b that are disposed near one another and in parallel. The fourth ion-sensitive semiconductor device 64 includes a seventh ion-sensitive semiconductor element 64a and an eighth ion-sensitive semiconductor element 64b that are disposed near one another and in parallel.

The first sensitive film 25a that is for the first ion-sensitive semiconductor element 61a, the third ion-sensitive semiconductor element 62a, the fifth ion-sensitive semiconductor element 63a, and the seventh ion-sensitive semiconductor element 64a respectively is provided on the first portion 51a of the semiconductor region of the substrate 51 as illustrated in FIG. 3. Further, these ion-sensitive semiconductor elements 61a˜64a include the first sensitive film 25a and the first sensor window 53a that is provided in the insulating film 53 so as to reach the first sensitive film 25a. Moreover, each of the ion-sensitive semiconductor elements 61a˜64a includes the first source region 55a and the first drain region 55b that have the second conductive type semiconductor provided at the substrate 51. The first portion 51a is provided between the first source region 55a and the first drain region 55b.

The second sensitive film 27a that is for the second ion-sensitive semiconductor element 61b, the fourth ion-sensitive semiconductor element 62b, the sixth ion-sensitive semiconductor element 63b, and the eighth ion-sensitive semiconductor element 64b respectively is provided on the second portion 51b of the semiconductor region of the substrate 51 as illustrated in FIG. 3. Further, these ion-sensitive semiconductor elements 61b˜64b include the second sensor window 53b that is provided in the insulating film 53 so as to reach the second sensitive film 27a. Moreover, each of the ion-sensitive semiconductor elements 61b˜64b includes the second source region 57a and the second drain region 57b that have the second conductive type semiconductor provided at the substrate 51. The second portion 51b is provided between the second source region 57a and the second drain region 57b. The first material of the first sensitive film 25a is different from the second material of the second sensitive film 27a.

The ion-sensitive semiconductor device integrated circuit 14 has a switch 65 that selects any one of the first ion-sensitive semiconductor device 61, the second ion-sensitive semiconductor device 62, the third ion-sensitive semiconductor device 63, and the fourth ion-sensitive semiconductor device 64.

For example, the switch 65 can connect any one of the first ion-sensitive semiconductor device 61, the second ion-sensitive semiconductor device 62, the third ion-sensitive semiconductor device 63, and the fourth ion-sensitive semiconductor device 64 to the signal input unit 17.

The signal input unit 17 receives respective signals from the first ion-sensitive semiconductor device 61, the second ion-sensitive semiconductor device 62, the third ion-sensitive semiconductor device 63, and the fourth ion-sensitive semiconductor device 64, and generates the sensor signal S_{SEN}. The signal processing unit 19 is connected to the signal input unit 17, and processes the sensor signal S_{SEN}.

As an example but not a limitation, in accordance with the ion-sensitive semiconductor device integrated circuit 14, the medium 100 can be measured by using at least two devices that are selected from among the ion-sensitive semiconductor devices 61, 62, 63, 64, and can obtain plural characteristic values (e.g., plural pH values). The signal processing unit 19 processes these characteristic values, and can generate the output signal S_{OUT} by, for example, calculating the arithmetic mean.

Or, in accordance with the ion-sensitive semiconductor device integrated circuit 14, the medium can be measured by using a single device that is selected in order from the ion-sensitive semiconductor devices 61, 62, 63, 64, and can obtain a single characteristic value. By such measuring, the cumulative energization time of each individual device can be reduced.

Or, the memory 21 can store the first data 21a and the second data 21c that are based on respectively different approximation formulas, for each of the ion-sensitive semiconductor devices 61, 62, 63, 64.

Or, one device can be selected from the ion-sensitive semiconductor devices 61, 62, 63, 64 in accordance with the type of the medium 100 that is to be measured.

The present disclosure is not limited to the above-described embodiments, and can be implemented by being modified in various ways within a scope that does not depart from the gist thereof. Further, all of these modifications are included in the technical concept of the present disclosure.

What is claimed is:

1. A measuring apparatus, comprising:
a first ion-sensitive semiconductor element disposed so as to be able to contact a medium of which a characteristic value is to be measured;
a second ion-sensitive semiconductor element disposed so as to be able to contact the medium;
a reference electrode, the medium being positioned between the reference electrode and the first and the second ion-sensitive semiconductor elements, and the reference electrode being disposed so as to be able to contact the medium;
a signal input unit configured to receive a first signal from the first ion-sensitive semiconductor element and a second signal from the second ion-sensitive semiconductor element, and generate a sensor signal;
a processor connected to the signal input unit and configured to process the sensor signal; and
a memory configured to store first data relating to fluctuations over time of the first ion-sensitive semiconductor element and the second ion-sensitive semiconductor element, and connected to the processor such that communication between the processor and the memory is possible, wherein:
the processor is configured so as to process the sensor signal by using the first data and a cumulative energization time of the first ion-sensitive semiconductor element and the second ion-sensitive semiconductor element, and generate an output signal for the characteristic value of the medium,
a first sensitive film of the first ion-sensitive semiconductor element includes a first material,
a second sensitive film of the second ion-sensitive semiconductor element includes a second material, and
the first material is different from the second material.

2. The measuring apparatus of claim 1, further comprising a timer that measures an energization time over which the first ion-sensitive semiconductor element and the second ion-sensitive semiconductor element are energized, wherein:
the processor updates the cumulative energization time based on the energization time, and
the memory stores the updated cumulative energization time received from the processor.

3. The measuring apparatus of claim 1, further comprising a temperature sensor for monitoring a temperature of the first ion-sensitive semiconductor element and the second ion-sensitive semiconductor element, wherein:
the temperature sensor generates a temperature signal expressing the temperature,
the memory stores second data that relates to changes, with respect to temperature, in the fluctuations over time of the first ion-sensitive semiconductor element and the second ion-sensitive semiconductor element, and
the processor processes the sensor signal by using the second data and the temperature signal, and generates the output signal.

4. The measuring apparatus of claim 1, wherein:
the characteristic value includes a hydrogen ion concentration of the medium,
the first sensitive film of the first ion-sensitive semiconductor element includes at least one of silicon oxide, silicon nitride, aluminum oxide, or tantalum oxide, and
the second sensitive film of the second ion-sensitive semiconductor element includes at least one of silicon oxide, silicon nitride, aluminum oxide or tantalum oxide, so as to differ from the first sensitive film.

5. A method of measuring a characteristic of a medium, the method comprising:
causing an ion-sensitive semiconductor device, which includes a first ion-sensitive semiconductor element having a first sensitive film of a first material and a second ion-sensitive semiconductor element having a second sensitive film of a second material that is different from the first material, to contact a medium of which a characteristic value is to be measured;
energizing a reference electrode that is made to contact the medium such that the medium is positioned between the reference electrode and the ion-sensitive semiconductor device;
after energizing the reference electrode and causing the ion-sensitive semiconductor device to contact the medium, obtaining a sensor signal relating to the medium from the first ion-sensitive semiconductor element and the second ion-sensitive semiconductor element; and
processing, by a processor, the sensor signal on the basis of first data relating to fluctuations over time of the first ion-sensitive semiconductor element and the second ion-sensitive semiconductor element, and a cumulative energization time of the ion-sensitive semiconductor device, so as to generate an output signal for the characteristic value.

6. The method of claim 5, further comprising:
measuring, via the processor, an energization time of the first ion-sensitive semiconductor element and the second ion-sensitive semiconductor element, and updating the cumulative energization time using the energization time; and
storing, via the processor, the cumulative energization time in a memory.

7. The method of claim 5, further comprising sensing, by a temperature sensor, temperature of the ion-sensitive semiconductor device and generating a temperature signal,
wherein the obtaining the sensor signal includes the processor processing the sensor signal by further using the temperature signal and second data relating to temperature changes in the fluctuations over time, and generating the output signal.

8. An ion-sensitive semiconductor device, comprising:
a substrate having a semiconductor region of a first conductive type;
an insulating film having a first sensor window and a second sensor window, and provided on the substrate;
a first sensitive film provided between a first portion of the semiconductor region and the first sensor window, and including a first material;
a first source region of a second conductive type that is different from the first conductive type, the first source region being provided at the semiconductor region;
a first drain region of the second conductive type, the first drain region being provided at the semiconductor region;
a second sensitive film provided between a second portion of the semiconductor region and the second sensor window, and including a second material;
a second source region of the second conductive type, the second source region being provided at the semiconductor region; and
a second drain region of the second conductive type, the second drain region being provided at the semiconductor region, wherein:
the first sensor window reaches the first sensitive film,
the second sensor window reaches the second sensitive film,
the first portion of the semiconductor region is between the first source region and the first drain region,
the second portion of the semiconductor region is between the second source region and the second drain region, and
the first material of the first sensitive film is different from the second material of the second sensitive film.
